(19) United States
(12) Patent Application Publication
(10) Pub. No.: US 2022/0387888 A1
(43) Pub. Date: Dec. 8, 2022

(54) SYSTEMS AND METHODS FOR DYNAMICALLY CONTROLLING A USER INTERFACE FOR FANTASY SPORTS TEAM MANAGEMENT

(71) Applicant: Lord & Bravo Enterprises, Inc., Flower Mound, TX (US)

(72) Inventor: Edgar BRAVO, Flower Mound, TX (US)

(21) Appl. No.: 17/749,352

(22) Filed: May 20, 2022

Related U.S. Application Data
(60) Provisional application No. 63/195,782, filed on Jun. 2, 2021.

(51) Int. Cl. A63F 13/46; A63F 13/828; G06V 20/40

(52) U.S. Cl. CPC A63F 13/46; A63F 13/828; G06V 20/42

(57) ABSTRACT

Disclosed herein are systems and method for dynamically controlling a user interface for fantasy sports team management. In one aspect, a method may include receiving player statistics for a fantasy sports team generated by a user. The method may include calculating a team score for the fantasy sports team, wherein the calculated team score is a function of player statistics associated with the players with an active status, and wherein player statistics associated with the players with an inactive status do not influence the team score. The method may include generating, on a user interface, an option to change a status of at least one player with the inactive status into the active status during the fantasy sports match, and changing, in real-time, the status of the at least one player into the active status when the option is selected. The method may include determining an updated team score.

### CROSS-REFERENCE TO RELATED APPLICATIONS

This application claims the benefit of United States Provisional Application No. 63/195,782, filed Jun. 2, 2021, which is herein incorporated by reference.

### FIELD OF TECHNOLOGY

The present disclosure relates to the field of fantasy sports games, and, more specifically, to systems and methods for dynamically controlling a user interface for fantasy sports team management.

### BACKGROUND

Fantasy sports (e.g., rotisserie, “roto”, head-to-head, daily, owner simulation, and the like) are games where participants act as owners to build a team that competes against other fantasy owners based on the statistics generated by the real individual players or teams of a professional sport. Each team owner can designate the players from the team roster as starters each week or day, and the designated players may be the individuals that score the fantasy points for the specific team owner.

However, in real life, players can be designated as ineligible to play or can be injured during the game. For example, a team may report a player as injured shortly before a game begins and the user may be offline and unable to substitute another player for the ineligible player. In this way, the user's fantasy sports team may score fewer points. Accordingly, a system and method is needed to enable a user to more dynamically manage fantasy rosters and gameplay.

### SUMMARY

In some aspects, the techniques described herein relate to a method for dynamically controlling a user interface for fantasy sports team management, the method including: receiving, from a server, player statistics for a fantasy sports team generated by a user, wherein the fantasy sports team includes players with an active status and players with an inactive status; calculating, during a fantasy sports match, a team score for the fantasy sports team, wherein the calculated team score is a function of player statistics associated with the players with the active status, and wherein player statistics associated with the players with the inactive status do not influence the team score; generating, on a user interface, an option to dynamically change a status of at least one player with the inactive status into the active status in the fantasy sports team during the fantasy sports match; in response to receiving a user selection of the option: changing, in real-time, the status of the at least one player into the active status; and dynamically updating the calculated team score to be an updated team score based on updated active statuses of the fantasy sports team; and generating the updated team score on the user interface.

In some aspects, the techniques described herein relate to a method, wherein the updated team score is a function of the player statistics associated with the players with the active status, wherein the players with the active status include the at least one player.

In some aspects, the techniques described herein relate to a method, wherein the user selection is received at a first time, and wherein the updated team score is calculated based on player statistics of the at least one player received after the first time.

In some aspects, the techniques described herein relate to a method, wherein the user selection is received at a first time, and wherein the updated team score is calculated based on player statistics of the at least one player received since a start of the fantasy sports match.

In some aspects, the techniques described herein relate to a method, wherein the option further includes another option to change a status of at least one other player with the active status into the inactive status in the fantasy sports team, further including: in response to receiving the user selection of the option changing the status of the at least one other player into the inactive status.

In some aspects, the techniques described herein relate to a method, wherein the another option enables statuses of the at least one player and the at least one other player to be swapped such that an equal number of players in the fantasy sports team change status.

In some aspects, the techniques described herein relate to a method, wherein the another option is generated in response to determining that player statistics of the at least one player may yield a higher team score than player statistics of the at least one other player.

In some aspects, the techniques described herein relate to a method, wherein the another option is generated in response to determining that the at least one player is compatible with a booster item and the at least one other player is not compatible with the booster item.

In some aspects, the techniques described herein relate to a method, wherein the another option is generated in response to determining that the at least one other player is no longer participating in a sports event during the fantasy sports match and that the at least one player is still participating in a sports event.

In some aspects, the techniques described herein relate to a method, wherein the user selection is received at a first time, and wherein the updated team score is calculated based on player statistics of the at least one other player received until the first time.

In some aspects, the techniques described herein relate to a method, wherein the updated team score is calculated without influence by player statistics of the at least one other player received during the fantasy sports match.

In some aspects, the techniques described herein relate to a method, wherein an amount of status changes is limited to a threshold amount of status changes allotted to the user for the fantasy sports match.

In some aspects, the techniques described herein relate to a method, wherein generating the option and the another option is in response to determining that the amount of status changes is not greater than the threshold amount of status changes.

In some aspects, the techniques described herein relate to a method, wherein generating the option is in response to determining that a number of the players with the active status is less than a maximum number of allowable players with the active status.

In some aspects, the techniques described herein relate to a method, further including: generating, on the user interface, another option to assign a booster item of a plurality of booster items to a player in the fantasy sports team with the active status, wherein the booster item applies adjustments to player statistics of the player in the fantasy sports team during calculation of a given team score.

In some aspects, the techniques described herein relate to a method, further including: in response to receiving a user selection of the another option, assigning the booster item to the player in the fantasy sports team.

In some aspects, the techniques described herein relate to a method, wherein the booster item is removed from the player after the fantasy sports match, further including generating a notification on the user interface that the booster item has been removed.

In some aspects, the techniques described herein relate to a method, wherein each respective booster item of the plurality of booster items has a booster type and a booster tier, wherein the booster type indicates compatible players that the respective booster item can be assigned to, and wherein the booster tier indicates a value of the respective booster item relative to other booster items.

It should be noted that the methods described above may be implemented in a system comprising a hardware processor. Alternatively, the methods may be implemented using computer executable instructions of a non-transitory computer readable medium.

In some aspects, the techniques described herein relate to a system for dynamically controlling a user interface for fantasy sports team management, including: a memory; and a hardware processor communicatively coupled with the memory and configured to: receive, from a server, player statistics for a fantasy sports team generated by a user, wherein the fantasy sports team includes players with an active status and players with an inactive status; calculate, during a fantasy sports match, a team score for the fantasy sports team, wherein the calculated team score is a function of player statistics associated with the players with the active status, and wherein player statistics associated with the players with the inactive status do not influence the team score; generate, on a user interface, an option to dynamically change a status of at least one player with the inactive status into the active status in the fantasy sports team during the fantasy sports match; in response to receiving a user selection of the option: change, in real-time, the status of the at least one player into the active status; and dynamically update the calculated team score to be an updated team score based on updated active statuses of the fantasy sports team; and generate the updated team score on the user interface.

In some aspects, the techniques described herein relate to a non-transitory computer readable medium storing thereon computer executable instructions for dynamically controlling a user interface for fantasy sports team management, including instructions for: receiving, from a server, player statistics for a fantasy sports team generated by a user, wherein the fantasy sports team includes players with an active status and players with an inactive status; calculating, during a fantasy sports match, a team score for the fantasy sports team, wherein the calculated team score is a function of player statistics associated with the players with the active status, and wherein player statistics associated with the players with the inactive status do not influence the team score; generating, on a user interface, an option to dynamically change a status of at least one player with the inactive status into the active status in the fantasy sports team during the fantasy sports match; in response to receiving a user selection of the option: changing, in real-time, the status of the at least one player into the active status; and dynamically updating the calculated team score to be an updated team score based on updated active statuses of the fantasy sports team; and generating the updated team score on the user interface.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a user interface for dynamically controlling a user interface for fantasy sports team management.

FIG. 2 is a block diagram illustrating a system for managing a fantasy sports team.

FIG. 3 is a block diagram illustrating a system for assigning booster items.

FIG. 4 is a block diagram illustrating a system for calculating a team score.

FIG. 5 is a block diagram illustrating a system for calculating a team score.

FIG. 6 is a block diagram illustrating a system for joining a fantasy sports match.

FIG. 7 is a block diagram illustrating a system for generating a scoreboard.

FIG. 8 illustrates a flow diagram of a method for dynamically controlling a user interface for fantasy sports team management.

FIG. 9 presents an example of a general-purpose computer system on which aspects of the present disclosure can be implemented.

### DETAILED DESCRIPTION

Exemplary aspects are described herein in the context of a system, method, and computer program product for dynamically controlling a user interface for fantasy sports team management. Those of ordinary skill in the art may realize that the following description is illustrative only and is not intended to be in any way limiting. Other aspects may readily suggest themselves to those skilled in the art having the benefit of this disclosure. Reference may now be made in detail to implementations of the example aspects as illustrated in the accompanying drawings. The same reference indicators may be used to the extent possible throughout the drawings and the following description to refer to the same or like items.

In general, fantasy sports set goals for team owners to accumulate as many points as possible by actively selecting the best combination of players (e.g., used interchangeably with “athletes”) as they play in a live sporting event. To do so, users may shuffle active athletes, switching them for another that the user may feel is performing better according to their strategic approach and to earn more fantasy points.

According to an exemplary aspect, a system and method is provided that includes the configurations and steps of providing an online fantasy sports league in which a user interacts with the online fantasy sports league via an application in a computing device. During gameplay, the exemplary system and method is configured to dynamically manipulate incoming fantasy data (e.g., in-game player statistics and corresponding points) to the advantage or disadvantage of the user, based upon certain parameters that are configured solely by the user through the means of equipped virtual items and preconfigured fantasy athletes.

In another exemplary aspect, the system and method disclosed herein enables the team owner with the ability to replace and switch underperforming or inactive athletes in order to improve their overall scoring in the electronic game. Through this process, the user (i.e., the team owner) has complete authority over the athlete replacements for a reserved athlete at their discretion until the culmination of the fantasy sports match.

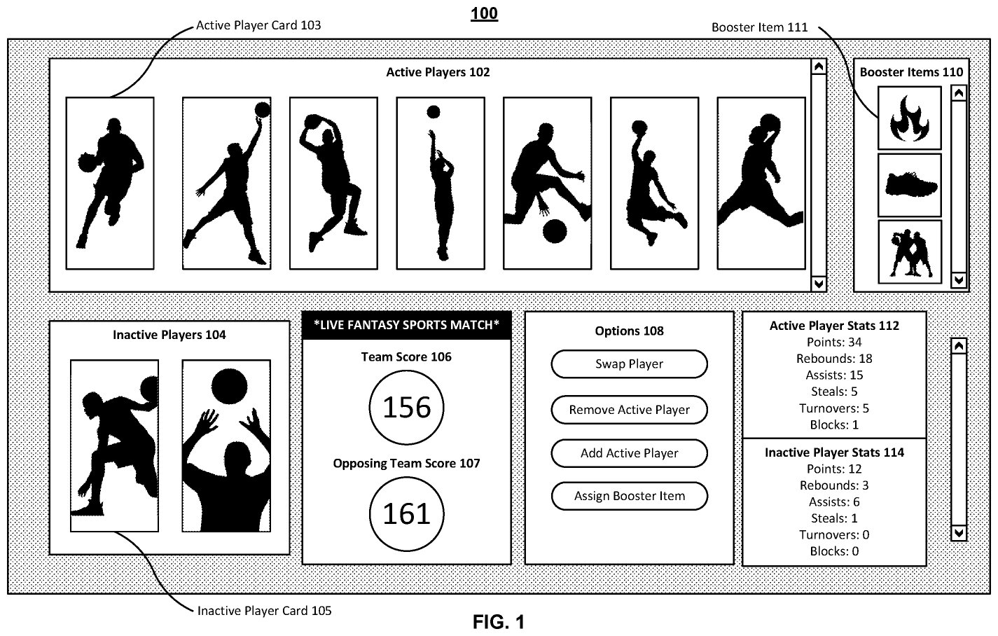

FIG. 1 is a block diagram illustrating user interface 100 for dynamically controlling a user interface for fantasy sports team management. User interface 100 may be a graphical user interface of a website or a web application accessed via a web browser. User interface 100 may also be a graphical user interface of an application locally installed on a computing device (e.g., a smartphone, a computer, a gaming console, etc.).

User interface 100 includes a first portion listing active players 102, a second portion listing inactive players 104, a third portion listing team scores (i.e., team score 106, opposing team score 107) for a fantasy sports match, a fourth portion listing options 108 that a user can select, a fifth portion listing player statistics of active players (i.e., active player stats 112) and inactive players (i.e., inactive player stats 114) for a fantasy sports match, and a sixth portion listing booster items 110. Each of the portions may be represented as windows within user interface 100. In some aspects, different portions of user interface 100 may be combined/merged. For example, the first portion listing active players 102 and the second portion listing inactive players 104 may be included in a single portion that lists active players 102 and inactive players 104.

A user may resize or reposition each portion within user interface 100. Likewise, the visual look of user interface 100 may be different depending on the configurations set by a developer of user interface 100. For example, in user interface 100 in FIG. 1, the first portion listing active players 102 and the second portion listing inactive players 104 each depict player cards. The player cards may each include an image of the corresponding player and identifiers of the player such as a player name, a player number, a team name associated with the player in the physical world, a position (e.g., point guard, shooting guard, etc.) of the player, etc. In some configurations of user interface 100, the visual look may resemble a table that lists this information. For example, the table may include rows and columns where each row represents a respective player and each column represents a particular identifier of the respective player.

A fantasy sports match may be a contest in a fantasy sports game that includes two or more players. As a player in the physical world earns points associated with the physical game, a user of the fantasy sports game earns virtual points that contribute to a team score. For example, if a basketball player makes two points in a game, a user that has the basketball player on his/her fantasy sports team may earn two virtual points in the fantasy sports match. The fantasy sports match may be limited to a period of time (e.g., a day, a weekend, a week, etc.). Accordingly, any physical games occurring during the period of time associated with the fantasy sports match can influence the team score. At the end of the fantasy sports match, the team score of the user (e.g., team score 106) is compared against the team score of the opposing user (e.g., opposing team score 107). The user with the higher team score wins the match.

In a conventional fantasy sports match, the team score is influenced solely by the player statistics of players with an active status. Before the fantasy sports match, the user is prompted to assign the active status to a select group of player. Depending on the rules of the fantasy sports match, there may be a threshold number of players that can be assigned the active status. For example, in a basketball fantasy sports game, the active status may be assigned to up to ten players. All remaining players are automatically assigned the inactive status. If a player with the inactive status earns points in the physical world, virtual points are not added/removed from the team score. Thus, the performance of a player with the inactive status cannot affect the team score. In contrast, if a player with the active status earns points in the physical world, virtual points are added/removed from the team score. Thus, the performance of a player with the active status affects the team score.

The game mechanics of the fantasy sports match motivate users to assess/predict the performance of a player on their fantasy sports team and assign active/inactive statuses accordingly. If a player is expected to underperform relative to another player, not play in the physical world due to an injury, suspension, or benching, or not have a game scheduled during the period of time of the fantasy sports match, a user is likely to assign the inactive status to the player. This is in an effort to optimize the team score and potentially win the fantasy sports match.

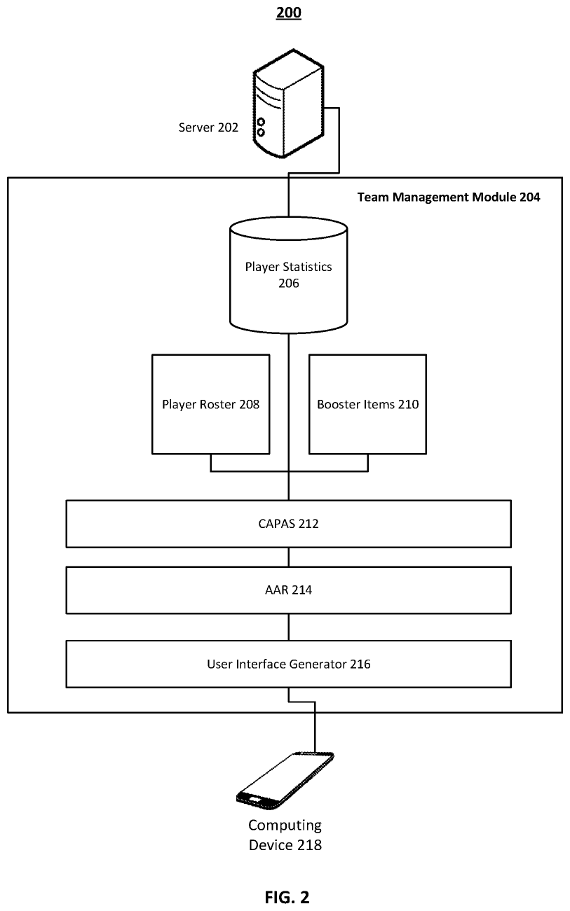

FIG. 2 is a block diagram illustrating system 200 for managing a fantasy sports team. In general, it is noted that the fantasy contests can be entered by one or more client devices. These clients can be hardware and/or software (e.g., threads, processes, computing devices) that are coupled to one or more servers. The client devices can communicate with the servers in the form of a data packet adapted to be transmitted between two or more computer processes. The system can include a communication framework that can be employed to facilitate communications between the clients and the servers. Moreover, the clients are connected to one or more client data stores that can be employed to store information local to the clients. In an exemplary aspect, a system can instead be a collection of remote computing services constituting a cloud-computing platform.

The present disclosure describes team management module 204 for managing fantasy sports teams that can aid the user in deciding active/inactive statuses and applying boosters to certain player statistics. Team management module 204 may be a software that is executed by server(s) 202, which is provided by a developer of the fantasy sports game. Team management module 204 includes player statistics 206, player roster 208, booster items 210, a Competitive Attributable Point Aggregation System (CAPAS) 212, an Active Athlete Replacement System (AAR) 214, and user interface generator 216. CAPAS 212 is configured to calculate team scores, apply booster items to player statistics, and recommend options. AAR 214 is configured to change the statuses of players and recommend options as well. The configurations and user interface generated by team management module 204 are transmitted to computing device 218, which may be a computer belonging to a user.

In some aspects, team management module 204 is split into a thin client application and a thick client application. The thin client application may be installed on computing device 218, and is configured to display user interface 100 and receive/transmit user selections to the thick client application installed on server 202. The thick client application is configured to execute the user selections, adjust configurations, receive player statistics, calculate team scores, etc.

In an exemplary aspect, team management module 204 receives, from a server, player statistics 206 for a fantasy sports team generated by a user. The server that provides player statistics 206 may be dedicated to updating player statistics in real-time based on player performance in live sports events. The fantasy sports team may include player roster 208, which is divided into players with an active status (e.g., active players 102) and players with an inactive status (e.g., inactive players 104). During a fantasy sports match, CAPAS 212 may calculate a team score for the fantasy sports team (e.g., team score 106). As mentioned before, team score 106 is a function of player statistics associated with the players with the active status. Player statistics associated with the players with the inactive status do not influence team score 106. For example, in FIG. 1, active player stats 112 lists player statistics of players with an active status and inactive player stats 114 lists player statistics of players with an inactive status. A mathematical combination of the active player stats 112 results in team score 106. For example, the mathematical combination may be: Team Score=2×Points+Rebounds+2×Assists+4×Steals−Turnovers+5×Blocks. Given the values in active player stats 112, the mathematical combination is Team Score=2×34+18+2×15+4×5−5+5×5=156 (i.e., the value of team score 106).

User interface generator 216 of team management module 204 may generate, on user interface 100 (as shown in FIG. 1), an option to dynamically change a status of at least one player with the inactive status into the active status in the fantasy sports team during the fantasy sports match. For example, options 108 may include a clickable button that states “Add Active Player.” In response to receiving a user selection of the option “Add Active Player,” AAR 214 may change, in real-time, the status of the at least one player into the active status. Suppose that a user selects “Add Active Player” from options 108. Team management module 204 may prompt the user to select a player card from inactive players 104. Suppose that the user selects inactive player card 105. In response, AAR 214 changes the status of the player associated with inactive player card 105 to the active status and prompts user interface generator 216 to update the first and second portions of user interface 100 (e.g., move inactive player card 105 to active players 102).

CAPAS 212 may then calculate an updated team score based on updated active statuses of the fantasy sports team. For example, player roster 208 may indicate that the selected player is now active. The player statistics produced by the selected player are then incorporated into team score 106. Suppose that the player associated with inactive player card 105 is the sole contributor to inactive payer stats 114 (e.g., the other player in inactive players 104 is not scheduled to play during the time period of the fantasy sports match). In one aspect, CAPAS 212 may include 12 points, 3 rebounds, 5 assists, 1 steal, 0 turnover, and 0 blocks into the calculation of team score 106. With the inclusion of these player statistics, the updated team score=2×(34+16)+18+3+2×(15+6)+4×(5+1)−5−0+5×(5+0)=207. User interface generator 216 may then generate the updated team score on user interface 100. Here, the updated team score is still a function of the player statistics associated with the players with the active status, but now the players with the active status include the at least one player (e.g., inactive player card 105).

In the example above, CAPAS 212 calculates the updated team score based on player statistics of the at least one player received since a start of the fantasy sports match. For example, inactive player stats 114 may be player statistics that the player associated with inactive player card 105 has earned since the start time of the fantasy sports match. However, in some aspects, the updated team score is calculated based on a time the user selection to change status was received. For example, the user selection may be received at a first time (e.g., halftime of a basketball game). CAPAS 212 may be configured to calculate the updated team score based on player statistics of the at least one player received after the first time. For example, despite producing inactive player stats 114, the player associated with inactive player card 105 may be treated as a new player. Physical points earned by the player after the first time are included into the calculation of the updated team score. However, physical points earned by the player during his/her time as an inactive player (i.e., after the start time of the fantasy sports match and before the first time) are not included in the calculation of the updated team score.

Suppose that the selected player remains active for the remainder of the fantasy sports match. If the selected player earns 10 points in the physical world after the first time, the 10 points are included in the updated team score. However, the 12 points produced before the first time (as seen in inactive player stats 114) are not included in the calculation. If the selected player is kept active in a first period of time during the fantasy sports match and is removed from the active status at the end of the first period of time, only the player statistics earned during the first period of time are included in the calculation.

In some aspects, options 108 further comprises another option to change a status of at least one other player with the active status into the inactive status in the fantasy sports team (e.g., “Remove Active Player”). When the user selects the “Remove Active Player” option, user interface 100 prompts the user to select a player card from active players 102. For example, the user may select active player card 103. In response to receiving the user selection of the “Remove Active Player” option, AAR 214 may change the status of the at least one other player into the inactive status (e.g., set the status of the player associated with active player card 103 to the inactive status). AAR 214 may further instruct user interface generator 216 to move active player card 103 into the inactive players 104 portion of user interface 100.

In some aspects, the another option enables statuses of the at least one player and the at least one other player to be swapped such that an equal number of players in the fantasy sports team change status. For example, options 108 includes the “Swap Player” option. When the user selects “Swap Player,” user interface 100 may prompt the user to select a player card from active players 102 and a player card from inactive players 104. Suppose the user selects inactive player card 105 and active player card 103. AAR 214 changes the status of the player of active player card 103 to the inactive status and the status of the player of inactive player card 105 to the active status. Suppose that the “Swap Player” option is selected at a first time. After AAR 214 executes the change at the first time, CAPAS 212 calculates the updated team score based on player statistics of the at least one other player associated with active player card 103 received until the first time. In other words, once the at least one other player has the inactive status starting from the first time, subsequent points earned by the at least one other player in the sports event do not influence the team score. In some aspects, when a player is removed from the active status, all points earned by the player since the start of the fantasy sports match are not included in the calculation of the updated team score. The logic behind including and excluding points based on when user selection is made is based on at least one of: game configurations set by a developer of the fantasy sports game, match rules set by participants (e.g., the user) of the fantasy sports match, and match rules set by participants of a fantasy sports league (e.g., a season with a set group of players) in the fantasy sports game.

In some aspects, the portion depicting options 108 changes based on recommendations from AAR 214 and CAPAS 212. For example, CAPAS 212 may compare active player stats 112 with inactive player stats 114. CAPAS 212 may determine if there is a configuration of player statuses that can maximize team score 106. Based on the actions needed to achieve the configuration, CAPAS 212 may recommend an option (e.g., “Swap Player”).

For example, “Swap Player” may be generated by user interface generator 216 in response to CAPAS 212 determining that player statistics of the at least one player associated with inactive player card 105 may yield a higher team score than player statistics of the at least one other player associated with active player card 103.

In some aspects, “Swap Player” may be generated by user interface generator 216 in response to AAR 214 determining that the at least one other player associated with active player card 103 is no longer participating in a sports event (e.g., the real-life basketball game) during the fantasy sports match and that the at least one player associated with inactive player card 105 is still participating in a sports event (e.g., the same or different real-life basketball game).

“Remove Active Player” may be generated by user interface generator 216 in response to CAPAS 212 determining that the player statistics of the at least one player associated with inactive player card 105 is decreasing the team score (e.g., the player has a larger magnitude of value-dropping statistics such as turnovers than value-adding statistics such as assists).

“Add Active Player” may be generated by user interface generator 216 in response to AAR 214 determining that a number of the players with the active status is less than a maximum number of allowable players with the active status (e.g., the user has 8 active players, but 10 active players are allowed).

In some aspects, an amount of status changes is limited to a threshold amount of status changes allotted to the user for the fantasy sports match. For example, a user may be given 10 status changes during the time period of the fantasy sports match. If the user reaches this threshold amount, CAPAS 212 and AAR 214 may no longer recommend options to the user. As a result, options 108 may no longer show “Swap Player,” “Remove Active Player,” and “Add Active Player” options.

In an exemplary aspect, CAPAS 212 may command user interface generator 216 to generate booster items 210 for view by the user. In response to receiving the command, user interface generator 216 may generate a visual representation of booster items 210 (e.g., Booster items 110). Booster items 110 is a portion of user interface 100 that includes a plurality of booster items, including booster item 111, that the user can assign to different players in player roster 208.

A booster item applies adjustments to player statistics 206 of the player in the fantasy sports team during calculation of a given team score. Each respective booster item of the plurality of booster items has a booster type. The booster type indicates compatible players that the respective booster item can be assigned to. For example, in a basketball fantasy sports game, a booster type may be specific to a position (e.g., a point guard), a type of statistic (e.g., assists), a player team (e.g., New York Knicks), etc. A player team-type booster item may, for example, increase a multiplier for a statistic if the player is playing in the team's city (e.g., increase steal multiplier from 5 to 6 if the player is playing in New York City). A position-type booster item may, for example, add a set number of points for a particular statistic when assigned to a player of a corresponding position (e.g., a point guard booster item may automatically add 5 assists to a player if the player is a point guard). Other types of booster items may limit the number of times the booster item is assigned to a player, may prevent a booster item from being transferred from one player to another, or may have no restrictions in terms of compatibility.

A booster item may also have a usage time limit or amount limit. For example, a particular booster item may only be used for three fantasy sports matches. In another example, a particular booster item may only be used for one day.

Each respective booster item also has a booster tier that indicates a value of the respective booster item relative to other booster items. For example, a tier may be “common,” “rare,” “ultra-rare.” A position-type booster item that is “common” may add only 5 assists to a player, whereas a position-type booster item that is “ultra-rare” may add 10 assists to a player. In general, higher booster tiers have greater benefits with respect to increasing the team score. In some aspects, higher booster tiers have higher usage limits/time limits associated with them.

Suppose that booster item 111 of the plurality of booster items 110 is a position-type booster item of a given tier (e.g., rare). Booster item 111 may double the point total of the assigned player. For example, if a player earns 15 points during the fantasy sports match, booster item 111 may change the point total to 30 points by the player. This boosted value is used by CAPAS 212 to calculate the updated team score. The presence of booster items adds another layer of strategy to the fantasy sports game. Users may assign different booster items to different players and determine whether the team score is maximized.

CAPAS 212 may also recommend booster options such as “Assign Booster Item” in options 108 in response to determining that the user has unassigned booster items that are compatible with one or more of active players 102. In response to receiving a user selection of “Assign Booster Item”, CAPAS 212 may assign the booster item (e.g., booster item 111) to the player in the fantasy sports team (e.g., the player associated with active player card 103).

In some aspects, when the booster item reaches a usage limit or time limit, CAPAS 212 may remove the booster item from the player after the fantasy sports match. CAPAS 212 may then instruct user interface generator 216 to generate a notification on user interface 100 indicating that the booster item has been removed. For example, booster item 111 may disappear from booster items 110 and be overlaid on active player card 103 when assigned to the player associated with active player card 103. When booster item 111 is removed from active player card 103, user interface generator 216 may reinstate booster item 111 in booster items 110 (or remove booster item 111 altogether from user interface 100 if booster item 111 cannot be assigned anymore due to usage limits).

In some aspects, “Swap Player” may be generated by user interface generator 216 in response to CAPAS 212 determining that the at least one player associated with inactive player card 105 is compatible with booster item 111 and the at least one other player associated with active player card 103 is not compatible with booster item 111.

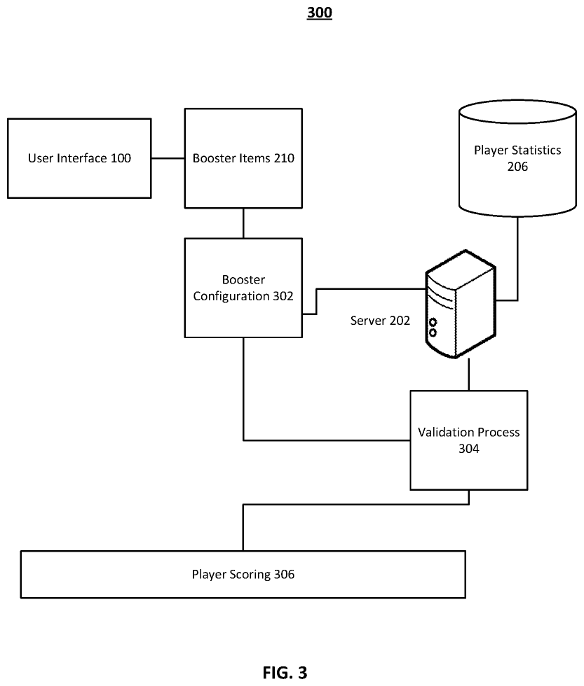

FIG. 3 is a block diagram illustrating system 300 for assigning booster items. According to an exemplary aspect, a system is provided that configures user interface 100 for a user (e.g., a team owner) to set and manage his/her fantasy team. In particular, the user can perform several roles (e.g., the owner, general manager and/or coach) of a fantasy sports team. In an exemplary league, each team can be allowed a predetermined number of players on its team, as well as a specified number at each position that can or must be used in each game (e.g. the “starters/active players”). Using user interface 100, the user can create or otherwise set a lineup as done in traditional fantasy games by selecting up to a predetermined number of athletes (e.g., 11 athletes) that can be considered as cards for purposes of this disclosure. In one example, 8 athletes may be chosen as the active deck of cards (i.e., the starters), while the 4 remaining may be in the inactive deck (also known as the bench). In the present disclosure, “starters” are the equivalent of players with an active status and “the bench” is equivalent to players with an inactive status.

In order to further supplement the skilled gaming approach of fantasy sports and to further enhance a strategic approach that users must utilize during the lineup creation process, the exemplary system configures a CAPAS 212 framework that serves as a key functionality for user engagement. In operation, upon lineup creation, the users may have the option to equip certain positions in their lineup with a fantasy accessory (e.g., booster items 210) that may boost the fantasy points received specifically by parameters that have been configured within each item or boosted fantasy athlete. Each accessory (used interchangeably with “booster item” and “booster”) that is equipped may have a set of point aggregators that may be calculated as the fantasy points data is received by the athletes' live performance during real-time games. CAPAS 212 also serves as a way to improve specific athletes points by manipulating the incoming fantasy data for the specific athlete.

More particularly, after lineup creation and when a user joins a match, the participant may be able to select point “boosters” that may function as additional bonuses to benefit their lineup. Using the electronic gaming interface, boosters are attachable items that a user can place upon certain players depending on their positions and the limitations of the booster itself. In one aspect, the boosters essentially give the user lineup more points when certain plays are performed. These passive point boosters may remain with the user's team and, in some aspects depending on game rules, cannot be changed until the match is over.

In one example, the boosters may be in two tiers: basic and epic. The basic boosters may be available to everyone in a match that contains an entry fee, for example, while the epic boosters may be available for an extra premium and only within premium matches. In a refinement of the exemplary aspect, all players (i.e., users) begin at Level 1, and with 1 out of 3 booster slots. As the player engages in more electronic fantasy competitions, the respective user may earn experience points that may enable them to eventually advance to higher levels. At higher levels, the participants may be able to unlock additional booster Slots that may collectively work in favor of the teams.

In operation, during the incoming flow of fantasy data (which can be accumulated from online and real-time data sources using conventional techniques), CAPAS 212 may manipulate the incoming data flow according to certain parameters that have been pre-configured through a gaming server (e.g., server 202). In an exemplary aspect, booster configuration 302 provides parameters that are comprised of specific virtual fantasy items that can be added to a lineup in the form of an attachable equipment or as an alternate variation of a pre-existing athlete. The parameters are mathematical sequences that are mutable server 202 and are subject to change according to the evolutionary process of the gaming development overtime to correct competitive equilibrium. Moreover, CAPAS 212 may contain parameters that may filter, process, and manipulate athlete specific fantasy data when certain conditions are met. This computational process may perform a mathematical sequence to manipulate the resulting data into the final form which may be credited to the user. This mathematical sequence consists of both positive and negative integers and varies in benefits and penalties.

Each booster that is selected by user interface 100 during gameplay can contain a mathematical equation configured to manipulate the incoming player statistics 206 within the server according to the equation in booster configuration 302. In an exemplary aspect, the configuration for booster items 210 may range from single to multiple data structures such as +0.4 points for home runs, −1.0 points for three-point shots, +4.0 points for 50 yard runs, as well as additional parameters to indicate specific conditions for these equations, for example Defensive players only, All Players, Captain players, Quarterbacks Only, Center Positions, and the like.

For example, in a basketball game, a booster may be designated for the center position in which case any player designated as playing the center position and that hits a three-point shot may get double points. Thus, player statistics 206 reports a center player making a 3 pointer in user interface 100 (i.e., “Center_Player scores 3 pts”). Server 202 receives this data and execute validation process 304 to confirm if current player has a booster equipped. If validation is authorized, the additional points (whether positive, negative, or both) may be calculated into total team score for the player (e.g., “Center_Player Scores 3 pts+Booster (value ×2)=total value 6”). This number is then credited to the player's total fantasy score (e.g., player scoring 306).

Yet further, the exemplary system provides for AAR 214 to automatically and dynamically make on-the-fly adjustments to a roster entry. In general, the system and method provides a configuration in that enables the user with the ability to replace and switch underperforming or inactive athletes in order to improve their overall scoring in the fantasy match by user interface 100. Through this process the user has complete authority over the athlete replacements for a reserved athlete at their discretion until the culmination of the fantasy sports match.

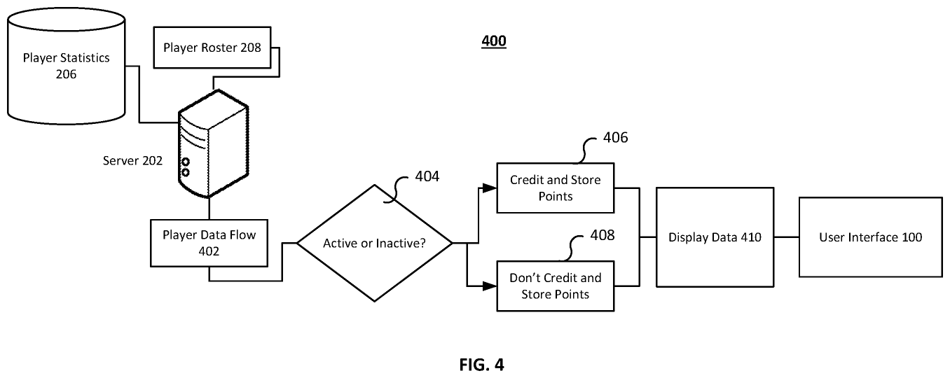

FIG. 4 is a block diagram illustrating system 400 for calculating a team score. In general, fantasy sports traditionally have a classic scoring model which is based upon the users creation of teams (or lineups) consisting of different athletes within the same sporting league, and submitting the teams into contests with the hopes of outscoring the other participants. These teams that are submitted are then locked in and cannot be adjusted at the user's may once the professional sports game has started, leaving the users with a model that is too similar to a lottery and not actual skill gaming.

According to an exemplary aspect, AAR 214 allows the user to seamlessly switch and replace their athletes for another that the user may have in their lineup. As described above, during the lineup creation phase, the user may select a set of athletes (e.g., 11 in total) that may be selected into their fantasy team. Seven of these athletes may be set on the active Slots (i.e., the starters) and may begin accumulating points as soon as their respective sporting events begin, while the remaining 4 may be stationed in the inactive slots and may not accumulate any points as bench players. In any moment during the fantasy sports match, the user may have the option to switch and replace an active athlete for another in the inactive slots or bench player. When the exchange has been performed, the selected active athlete may be stationed in the inactive slot and points may seize immediately to be aggregated into the users total team score. Likewise, the inactive athlete becomes active and the new athletes' points may begin to be credited from that moment onwards or until that athlete is replaced again at the user's complete discretion.

Thus, during gameplay, if the user can see by the interface that the inactive (or benched) deck may also display points that could have been counted towards the total, but since it is not in the active deck, the points may not be counted. Thus, the exemplary system and method enables the user to dynamically choose which cards (or athletes) they wish to exchange from the inactive to the active deck (at their discretion) in order to accumulate the most points possible by the end of the match. In one aspect, the user is allowed a predetermined (e.g., 10) card exchanges. In another aspect, the user can make an unlimited number of card exchanges. As a result, the participant must be fully engaged to make the best decisions possible and must consider that even if their benched player is currently playing, they may miss out on points. As shown, during this process, a stream of incoming data may flow into the gaming server that is configured to manage the data from the live gaming event. A data flow 402 switch may be allocating the fantasy data into the corresponding data field, which may then be stored into the display data 410 via the user interface 100. At 404, CAPAS 212 may determine if a player is active or inactive. For players with the active status, at 406, CAPAS 212 may credit and store points for active status players and at 408, CAPAS 212 may not credit nor store points for inactive status players. The incoming fantasy data may be separated depending on the respective user's deck (lineup) configuration. The configuration of the deck (lineup) may be determined by the user by allocating 7 cards (athletes as starters) into the active section, and 4 cards into the inactive section as backup players. During the incoming data flow, all of the fantasy points may pass through the active/inactive filter and be recorded in the display data 410.

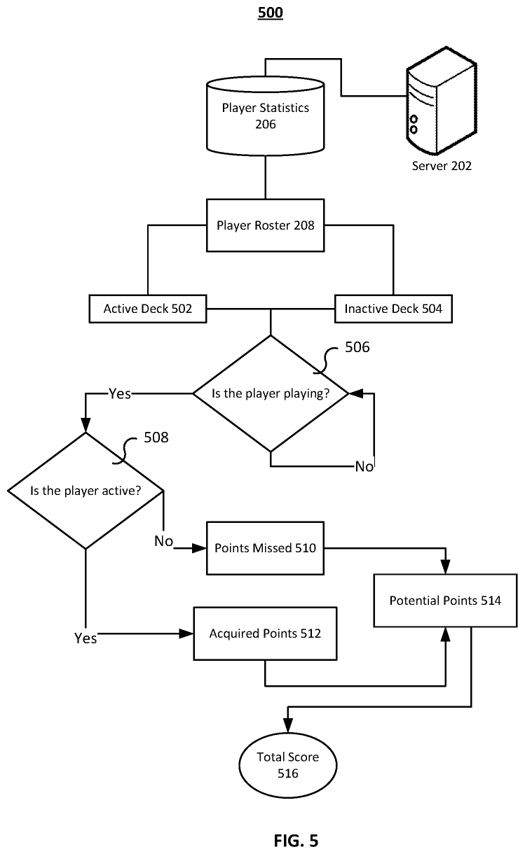

FIG. 5 is a block diagram illustrating system 500 for calculating a team score. The display data may structure the fantasy data to credit the user with valid fantasy points only for the athletes that have been allocated in the active status (e.g., active deck 502) of the player roster 208 as current playing athletes (i.e., active athletes). The fantasy data that has been received by the inactive filter, may therefore be structured by the display data, as points that were missed and may not be credited to the user (e.g., points associated with athletes in inactive deck 504). AAR 214 may determine at 506 if a player is playing in a sports event. If the player is playing, at 508, AAR 214 may determine whether the player is active.

Fantasy points that have been recorded into the inactive filter may be displayed to the user as “Points Missed” 510. Fantasy points that have been recorded into the active filter may be displayed as “Acquired Earned” 512 to the user and sent to public display (e.g., the public scoreboard). “Potential Points” 514 is a sum of Acquired Points 512 and Points Missed 510. Total score 516 the difference between Potential Points 514 and Points Missed 510. AAR 214 may be continuously active throughout the live match and its mechanism is entirely based and reliant on user input throughout the contest to switch player cards between active and inactive status. The AAR system and methodology may allow the user to switch any athlete at any given time into the active or inactive field of their current deck (lineup) according to their input received via the user interface.

According to another exemplary aspect, the system and method is configured to perform a halftime shuffle. That is, at the half-time point of a sports event, the user may have a timeframe (i.e., a half-time phase) in which they may be able to adjust their lineup to further increase their chances of winning a competition. During the half-time phase, the participant may be given the opportunity to engage with a new lineup. This new lineup may allow a user to reorganize or re-create the current lineup with players that are available from the current time until the culmination of the sporting event. At the end of the match, the results may be displayed in full transparency to all participants.

Yet further, in an exemplary aspect, those participating in a live match may be able to send messages to the entire audience, but limited to that specific match. If user is participating in multiple matches at the same, the user may be able to send messages in both matches via communication portion (not shown) of user interface 100.

Moreover, the system and method can be configured to offer mini-matches. For example, mini sessions where 11 (NFL standards) cards (athletes) are selected between two teams that may play during a live match. The 11 cards are selected by the participant in a ⅚ allocation (5 from one team, 6 from the other). Moreover, 7 may be selected as active, while the other 4 may be selected as inactive. Participants may then switch their athletes from the inactive/active competing for the most accumulated points in the match. NBA Variation may feature 5 card draws ( 3/2), MLB variation may feature 9 card draw ( 5/4), for example.

Yet further, users can participate to select the desired sports category (NFL, NBA, MLB, or FIFA etc.) and then may choose athlete cards to create their deck which they may use to compete with others. In one aspect, each athlete card may come at a cost (traditionally, athlete cost is termed as salary, but to differentiate the concept we may use another terminology which is yet to be determined). However, certain athlete cards may come with their unique bonuses which must be selected at players strategic discretion. These special card variations may be the result of a business collaboration to enhance monetization efforts within the games digital economy. For instance, UnderArmor® may agree to create a unique variation of an NBA player card which the participant may be able to freely use during any event. These cards may have unique perks and bonuses of their own and cannot be used together with many of the booster enhancements which the game may also feature.

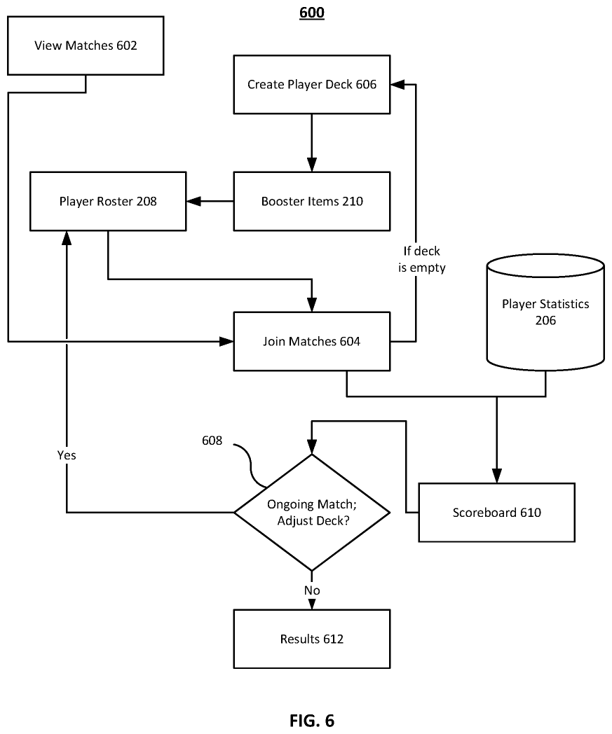

FIG. 6 is a block diagram illustrating system 600 for joining a fantasy sports match. A user may utilize a view matches function (e.g., View Matches 602) of user interface 100 to join available fantasy sports matches. Upon selecting a match, the user may utilize a join matches function (e.g., Join Matches 604). If the user deck is empty, the user may utilize a deck creation function (e.g., Create Player Deck 606). The user may further assign booster items 210 to different active players in the created deck, which includes player roster 208. CAPAS 212 may pull player statistics 206 for the player roster 208 and apply booster items 210 to update scoreboard 610. At 608, the user may be prompted to adjust the deck (e.g., change active/inactive statuses). Based on the user selection, scoreboard 610 is updated and results 612 of the fantasy sports match are displayed.

Yet further, in one exemplary aspect, the system and method can provide for a head to head match that utilizes an auto-matchmaking process that may put two participants together for a winner takes all matchup. Players may be automatically sorted out by Wins/Loss ratio in order to move away the more experienced players from the novice players. Alternatively, a group head-to-head contents can be executed in which users may be able to create teams with other users (e.g., 10 members maximum). These teams may be able to go against other teams to compete for a winner takes all battle.

Yet further, in one exemplary aspect, the system and method can provide for A.I. matches—man vs machine. In this instance, participants may be able to go head-to-head with bots in varying difficulty levels. Rewards may be given directly from the system if the A.I. has been successfully defeated.

As noted above, the system and method can provide for player boosters that are provided to supplement the players active deck. Boosters can be either purchased or earned and remain passive throughout the match. These boosters may come with different advantages as well as disadvantages and may further increase the difficulty of the game when used. A secondary purpose behind the boosters may also serve to further balance out the gameplay granting the less skilled players to have an advantage over the highly experienced mathematical players who create their lineup based off countless data and not out of passion.

As shown, the user interface enables to configure the boosters which can then be stored in the fantasy game server for the online match. Moreover, the fantasy data (e.g., the real-time game data) can be fed to the servers to process the booster scoring. A validation process confirms the computation of the different boosters (as discussed in more detail below) and then updates the player scoring.

The boosters, although optional can have a negative impact on these statistical data driven players if not also wisely weighed in. Boosters may be chosen when a lineup has been selected for a match, prior to lineup selection the participant may be brought to a screen which may display a roster of selected athletes and may be given the option to choose a booster based on the athlete's position. The boosters, however, can always be adjusted at the participants (users) discretion but only before a match has started.

According to an exemplary aspect, boosters of the lowest tier (e.g., basic or common) can be provided and free for all participants whether they are playing a free game or a premium paid match. These may have lesser point aggregating benefits (and disadvantages) when placed upon a lineup. Alternatively or in addition thereto, higher-tier boosters (e.g., ultra-rare, epic, etc.) are premium boosters available for purchase and may feature a greater point aggregation, but may also come with some cons which may serve a strategic approach in finalizing the lineup creation. Epic boosters, for example, may only be limited to a single use per match and per lineup. Booster examples include:
“Foul Play” (e.g., Fouls are ×2)
“Sharpshooter” (e.g., Free Throws are +3 pts, but 3 pointers are −2)
“Unstoppable” (e.g., Inactive Deck accumulates 10% worth of points)
“Golden Medal” (e.g., Experience Bonus ×4)

As disclosed above, the system and method can be implemented with a user interface for enabling participants (i.e., users) to enter the fantasy matches.

During a live match, the participant may no longer have to wait and see how their lineup submission performs. Instead, the participant has multiple options depending on what their approach is using the exemplary algorithms described above. The ultimate goal is to score as many points as possible with the selected athlete lineup combination. Moreover, multiple lineups can be submitted for gameplay within a certain match and, the more lineups that are submitted, the more action the participant may have while watching the live game. Moreover, during a live match, the participant may be required to manage their participating lineups.

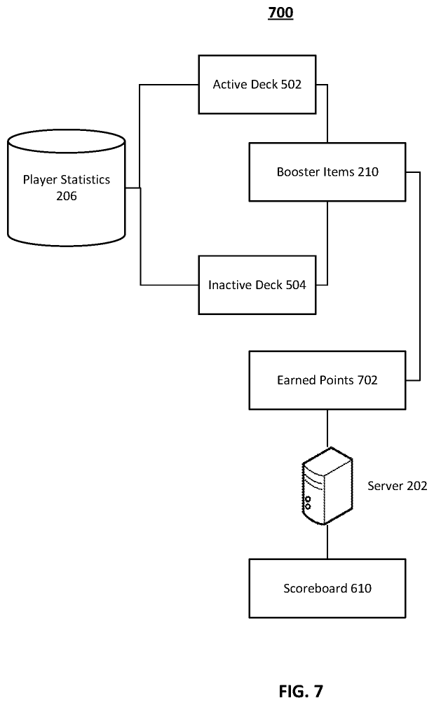

FIG. 7 is a block diagram illustrating system 700 for generating a scoreboard. Player roster 208 may be divided into active deck 502 (with active status players) and inactive deck 504 (with inactive status players). CAPAS 212 on server 202 may apply booster items 210 to player statistics to determine earned points 702. Earned points 702 is entered in scoreboard 610, which is shown on user interface 100. As described above, there may be 7 active and 4 inactive athletes in each lineup during a live match. Only the cards that are placed in the active section may be counted and added to the total team score. There may be instances where all players in the lineup(s) may be playing during the live game, and this is the critical moment where the participant may have to make the best choices regarding who to keep active and who to switch out for a better performing player.

Moreover, in an exemplary aspect, boosters may play a critical part, as it may give a better hand in scoring more points. Boosters may only affect the positions of the team indicated in the booster item that has been selected. Each may vary in its own unique way with advantages and disadvantages. While boosters are entirely optional, equipping one can become a determining factor for a solid victory if strategically played. Other competing players may not know the boosters that you have selected before a match has begun. After the match has finished, the details of selected boosters may become transparent with other competitors for a time-period through the scoreboard.

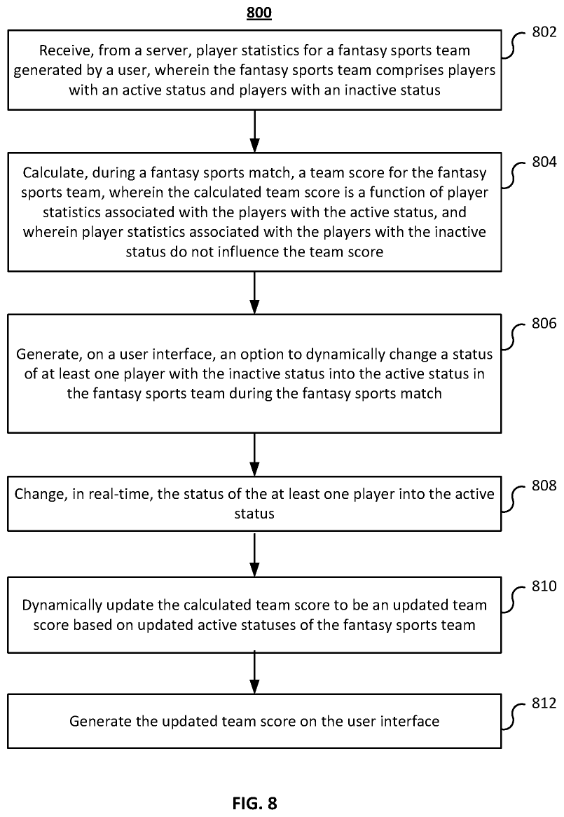

FIG. 8 illustrates a flow diagram of method 800 for managing a fantasy sports team. At 802, team management module 204 receives, from a server, player statistics for a fantasy sports team generated by a user, wherein the fantasy sports team comprises players with an active status and players with an inactive status. At 804, team management module 204 calculates, during a fantasy sports match, a team score for the fantasy sports team, wherein the calculated team score is a function of player statistics associated with the players with the active status, and wherein player statistics associated with the players with the inactive status do not influence the team score. At 806, team management module 204 generates, on a user interface, an option to dynamically change a status of at least one player with the inactive status into the active status in the fantasy sports team during the fantasy sports match. At 808, in response to receiving a user selection of the option, team management module 204 changes the status of the at least one player into the active status. At 810, team management module 204 dynamically updates the calculated team score to be an updated team score based on updated active statuses of the fantasy sports team. At 812, team management module 204 generates the updated team score on the user interface.

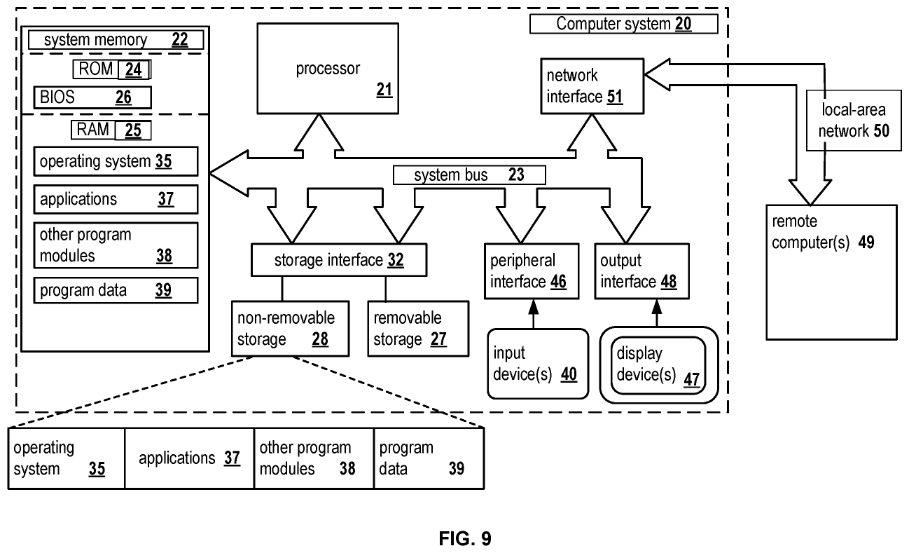

FIG. 9 is a block diagram illustrating a computer system 20 on which aspects of systems and methods for dynamically controlling a user interface for fantasy sports team management may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-8 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals may vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for dynamically controlling a user interface for fantasy sports team management, the method comprising:
receiving, from a server, player statistics for a fantasy sports team generated by a user, wherein the fantasy sports team comprises players with an active status and players with an inactive status;
calculating, during a fantasy sports match, a team score for the fantasy sports team, wherein the calculated team score is a function of player statistics associated with the players with the active status, and wherein player statistics associated with the players with the inactive status do not influence the team score;
generating, on a user interface, an option to dynamically change a status of at least one player with the inactive status into the active status in the fantasy sports team during the fantasy sports match;
in response to receiving a user selection of the option:
changing, in real-time, the status of the at least one player into the active status; and
dynamically updating the calculated team score to be an updated team score based on updated active statuses of the fantasy sports team; and
displaying the updated team score on the user interface.

2. The method of claim 1, wherein the updated team score is a function of the player statistics associated with the players with the active status, wherein the players with the active status include the at least one player.

3. The method of claim 2, wherein the user selection is received at a first time, and wherein the updated team score is calculated based on player statistics of the at least one player received after the first time.

4. The method of claim 2, wherein the user selection is received at a first time, and wherein the updated team score is calculated based on player statistics of the at least one player received since a start of the fantasy sports match.

5. The method of claim 1, wherein the option further comprises another option to change a status of at least one other player with the active status into the inactive status in the fantasy sports team, further comprising:
in response to receiving the user selection of the option changing the status of the at least one other player into the inactive status.

6. The method of claim 5, wherein the another option enables statuses of the at least one player and the at least one other player to be swapped such that an equal number of players in the fantasy sports team change status.

7. The method of claim 6, wherein the another option is generated in response to determining that player statistics of the at least one player may yield a higher team score than player statistics of the at least one other player.

8. The method of claim 6, wherein the another option is generated in response to determining that the at least one player is compatible with a booster item and the at least one other player is not compatible with the booster item.

9. The method of claim 6, wherein the another option is generated in response to determining that the at least one other player is no longer participating in a sports event during the fantasy sports match and that the at least one player is still participating in a sports event.

10. The method of claim 5, wherein the user selection is received at a first time, and wherein the updated team score is calculated based on player statistics of the at least one other player received until the first time.

11. The method of claim 5, wherein the updated team score is calculated without influence by player statistics of the at least one other player received during the fantasy sports match.

12. The method of claim 11, wherein an amount of status changes is limited to a threshold amount of status changes allotted to the user for the fantasy sports match.

13. The method of claim 12, wherein generating the option and the another option is in response to determining that the amount of status changes is not greater than the threshold amount of status changes.

14. The method of claim 1, wherein generating the option is in response to determining that a number of the players with the active status is less than a maximum number of allowable players with the active status.

15. The method of claim 1, further comprising:
generating, on the user interface, another option to assign a booster item of a plurality of booster items to a player in the fantasy sports team with the active status, wherein the booster item applies adjustments to player statistics of the player in the fantasy sports team during calculation of a given team score.

16. The method of claim 15, further comprising:
in response to receiving a user selection of the another option, assigning the booster item to the player in the fantasy sports team.

17. The method of claim 16, wherein the booster item is removed from the player after the fantasy sports match, further comprising generating a notification on the user interface that the booster item has been removed.

18. The method of claim 15, wherein each respective booster item of the plurality of booster items has a booster type and a booster tier, wherein the booster type indicates compatible players that the respective booster item can be assigned to, and wherein the booster tier indicates a value of the respective booster item relative to other booster items.

19. A system for dynamically controlling a user interface for fantasy sports team management, comprising:
a memory; and
a hardware processor communicatively coupled with the memory and configured to:
receive, from a server, player statistics for a fantasy sports team generated by a user, wherein the fantasy sports team comprises players with an active status and players with an inactive status;
calculate, during a fantasy sports match, a team score for the fantasy sports team, wherein the calculated team score is a function of player statistics associated with the players with the active status, and wherein player statistics associated with the players with the inactive status do not influence the team score;
generate, on a user interface, an option to dynamically change a status of at least one player with the inactive status into the active status in the fantasy sports team during the fantasy sports match;
in response to receiving a user selection of the option:
change, in real-time, the status of the at least one player into the active status; and
dynamically update the calculated team score to be an updated team score based on updated active statuses of the fantasy sports team; and
display the updated team score on the user interface.

20. A non-transitory computer readable medium storing thereon computer executable instructions for dynamically controlling a user interface for fantasy sports team management, including instructions for:
receiving, from a server, player statistics for a fantasy sports team generated by a user, wherein the fantasy sports team comprises players with an active status and players with an inactive status;
calculating, during a fantasy sports match, a team score for the fantasy sports team, wherein the calculated team score is a function of player statistics associated with the players with the active status, and wherein player statistics associated with the players with the inactive status do not influence the team score;
generating, on a user interface, an option to dynamically change a status of at least one player with the inactive status into the active status in the fantasy sports team during the fantasy sports match;
in response to receiving a user selection of the option:
changing, in real-time, the status of the at least one player into the active status; and
dynamically updating the calculated team score to be an updated team score based on updated active statuses of the fantasy sports team; and
displaying the updated team score on the user interface.
